(19) United States
(12) Patent Application Publication
(10) Pub. No.: US 2012/0171559 A1
(43) Pub. Date: Jul. 5, 2012

(54) BATTERY HOUSING HAVING A SEALING PLATE

(75) Inventors: Claus-Rupert Hohenthanner, Hanau (DE); Joerg Kaiser, Kamenz (DE); Andreas Gutsch, Luedinghausen (DE); Claudia Brasse, Hanau (DE); Tim Schaefer, Niedersachswerfen (DE)

(73) Assignee: LI-TEC BATTERY GMBH, Kamenz (DE)

(21) Appl. No.: 13/260,954

(22) PCT Filed: Mar. 18, 2010
(86) PCT No.: PCT/EP10/01722

§ 371 Date: Mar. 16, 2012

(30) Foreign Application Priority Data
Mar. 31, 2009 (DE) 10 2009 015 686.0

(51) Int. Cl. H01M 2/10; H01M 10/04; H01M 2/04; H01M 2/02; H01M 2/08

(52) U.S. Cl. 429/185; 429/186; 29/623.2

(57) ABSTRACT

The invention relates to a battery housing (1) for receiving one or more battery cells (2), comprising a cover surface (3), a floor surface (4), and a sealing plate (5) disposed between the cover surface and the floor surface. The invention further relates to a retaining frame (10) for a battery cell (2), comprising a floor part (11), a cover part (12), and a sealing part (12) disposed between the floor part and the cover part.

Priority application DE 10 2009 015 686.0 is fully incorporated by reference into the present application.

The invention relates to a battery housing for receiving one or more battery cells and to a retaining frame for a battery cell.

Conventional battery housings comprise a receiving space in which battery cells can be received. Both the electric contacting of the battery cells and the cooling take place in this common receiving space.

It is the object of the present invention to improve a battery housing for receiving battery cells.

The object of the invention is achieved by a battery housing for receiving one or more battery cells, comprising a cover surface, a bottom surface, and a sealing plate disposed between the cover surface and bottom surface.

The sealing plate, which is disposed between the cover surface and the bottom surface, preferably separates a first space of the battery housing from a second space of the battery housing. A first one of the separated spaces can preferably be provided for the electric contacting of the battery cells and can preferably constitute a contacting space. For this purpose, in an assembled state, the current conductors of a battery cell can extend into this first space.

A second space of the battery housing can be provided for cooling the battery cells and can preferably constitute a cooling space. For this purpose, the majority of a battery cell, in particular heat conducting sections of battery cells, preferably extend into this second space in an assembled state. To this end, the sealing plate comprises at least one aperture through which a battery cell can extend so as to protrude at least in sections both into the first space and into the second space. To this end, the sealing plate comprises one aperture per battery cell. Each battery cell can thus extend through a dedicated aperture through the sealing plate.

By configuring different spaces, the contacting of the battery cell can be spatially separated from the cooling of the battery cell. It is thus possible in particular to carry out the contacting under different ambient conditions than the cooling. The contacting can notably take place in a closed gaseous environment, while the cooling is notably performed by means of a liquid or ambient air. The cooling medium can preferably have direct contact with the battery cell. In particular when utilizing ambient air, it is thus ensured that no condensate can penetrate into the region of the electric contacting. In particular when utilizing ambient air for cooling the battery cells, the cooling space can be connected such that an exchange of cooling medium with the surroundings is possible. The housing can notably comprise apertures in the region of the cooling space which allow notably ambient air to pass through the battery housing.

The sealing plate can have an integral design. The apertures are preferably configured by openings in the sealing plate. As an alternative, the sealing plate can have a multi-part design and be formed in particular by a plurality of sealing plate elements. Preferably, a plurality of sealing plate elements are disposed in a plane. While in this case the apertures can be formed by real openings on individual sealing plate elements, the apertures, however, are preferably formed by clearances provided between two adjoining sealing plate elements. It is thus not necessary to configure real openings in a sealing plate element.

Recesses or bulges can be provided on edges of individual sealing plate elements, whereby room is created for a part of a battery cell to extend through. This facilitates the assembly or production of sealing plate elements. A sealing plate element can extend around an aperture in a U shape.

The sealing plate elements can come in contact with each other. However, the sealing plate elements can also be designed spaced from each other. The clearances created by the spacing of the sealing plate elements can be apertures through which battery elements can extend.

Sealing means are preferably provided on the apertures. The sealing means seal an annular space between the aperture and a battery cell that extends through the aperture. Due to the sealing means, preferably hermetic sealing is achieved of the two spaces with respect to each other. The hermetic seal of the two spaces with respect to each other can also be produced by other means.

The object of the invention is further achieved by a retaining frame for a battery cell, comprising a bottom part, a cover part, and a sealing part disposed between the bottom part and cover part. The bottom part preferably forms a lower delimitation of the retaining frame. The cover part preferably forms an upper delimitation of the retaining frame. The sealing part is disposed between the bottom part and the cover part and is preferably used to separate a first space from a second space in a battery housing. To this end, the sealing part can cooperate with a further element, for example a partition of the battery housing. As an alternative, the sealing part can cooperate with the sealing part of an adjacent retaining frame.

Connecting means are preferably provided between the cover part and the sealing part and/or between the sealing part and the bottom part. The connecting means can be lateral struts, which preferably give the retaining frame a rectangular shape. The retaining frame can be configured as a peripheral frame. Irrespective of this, in particular the sealing part, or another part of the retaining frame, can be disposed inside or outside of the frame.

The retaining frame can preferably be formed by frame halves. The frame halves can be configured identically. To this end, a battery cell, which is held by the retaining frame, can be received at least in sections between the two frame halves.

The retaining frame can also be disposed partially inside a jacket of the battery cell. To this end, the retaining frame, together with the electric cell, can be enclosed by a common jacket. As an alternative, the retaining frame can also be disposed completely outside of a jacket of the battery cell. Parts of the retaining frame can be disposed inside the jacket of the battery cell and parts of the retaining frame can be disposed outside of the jacket of the battery cell.

The retaining frame may comprise a reinforcement plate for this purpose. The reinforcement plate can be designed integrally in part with other components of the retaining frame, in particular with the bottom part and/or the cover part and/or the sealing part.

The sealing part comprises an aperture, which is preferably provided with sealing means. To this end, the aperture may be designed to be open on one side. The aperture can be formed in particular by an indentation or a cutout on an edge of the sealing part. The sealing part can cooperate with a sealing part of a retaining frame to be disposed adjacently so that the sealing parts of the retaining frames form an aperture. The battery cell can extend through the aperture. Sealing elements can be disposed on the apertures.

The retaining frame preferably comprises a groove for receiving a fastening flange of a battery cell. The groove can preferably be designed to be peripheral. The retaining frame can comprise two frame halves. A groove can divide the retaining frame into the two frame halves. A jacket of the battery cell can preferably be flange-mounted to sections of the retaining frame. To this end, the retaining frame as such can constitute a part of the battery seal.

In a preferred embodiment of the invention, a battery housing of the type mentioned above comprises a plurality of retaining frames of the type mentioned above. To this end, the retaining frames can preferably form parts of the battery housing. It is provided in particular that the cover surface of the battery housing is formed by a plurality of cover parts of the retaining frames. Moreover, the bottom surface of the battery housing can be formed by a plurality of bottom parts of the retaining frames. Furthermore, the sealing plate of the battery housing can be formed by a plurality of sealing plates of the retaining frames.

A battery housing can be composed of a plurality of retaining frames in a modular fashion, which enables easy assembly of the battery housing. To this end, battery cells are first connected to a retaining frame. Thereafter, a first retaining frame is placed against a second retaining frame. This can be repeated several times until a desired number of retaining frames, and thus battery cells, are located next to each other. Closing plates can be placed at the respective axial ends so as to close the axial ends. The retaining frames can be rigidly connected to each other. The retaining frames can preferably be braced with respect to each other by bracing means. It is not absolutely necessary for the battery cells to be connected to the retaining frame in a method. For example, the retaining frames can have already been connected to battery cells prior to assembly. In this case, the method can be started by placing each of the retaining frames against a further retaining frame.

The invention will be explained in more detail based on the following figures. In the drawings:

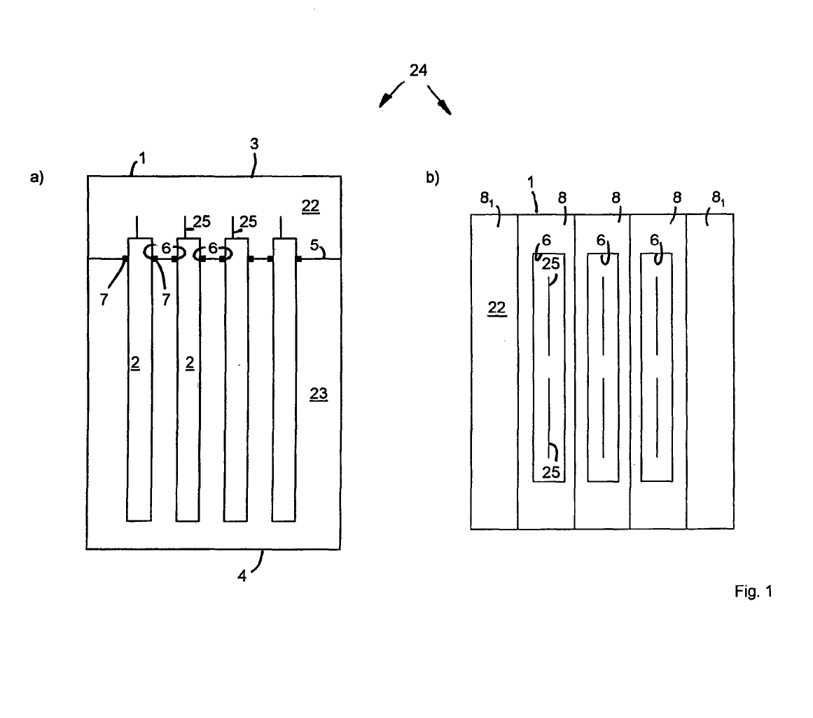

FIG. 1 shows a battery array comprising a battery housing according to the invention
a) in a sectional view,
b) in a top view;

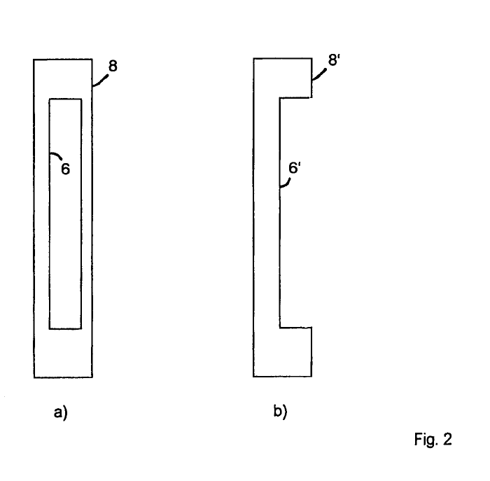

FIG. 2 shows a sealing plate element of a battery housing according to FIG. 1,
a) in a first embodiment,
b) in a second embodiment;

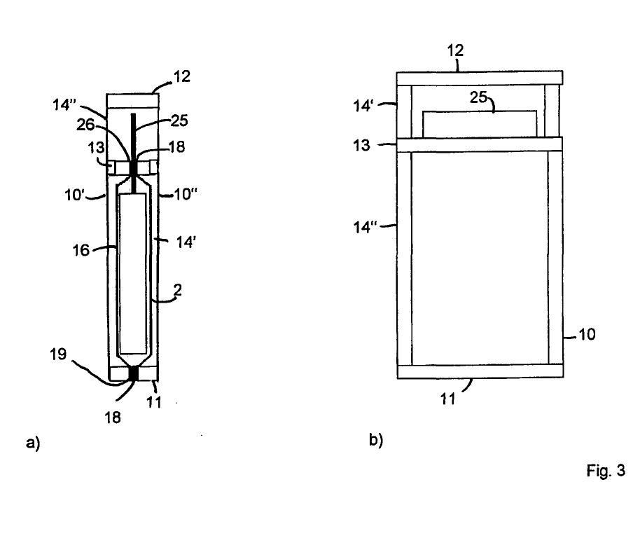

FIG. 3 shows a retaining frame according to the invention in a first embodiment,
a) in a sectional view,
b) in a top view;

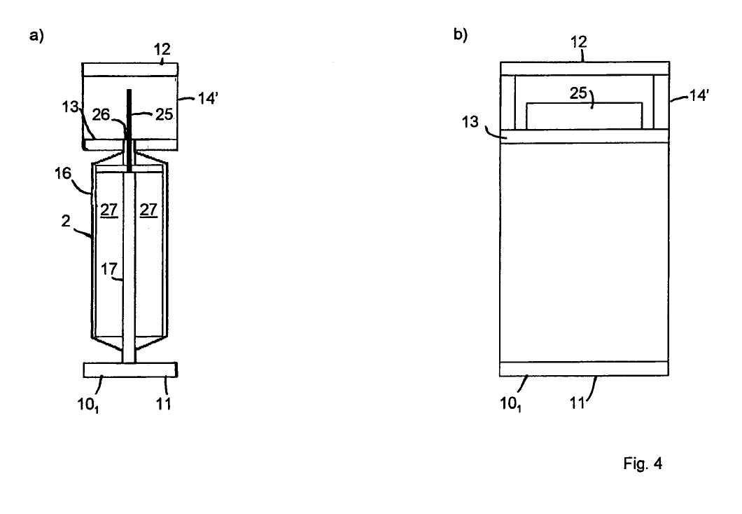

FIG. 4 shows a retaining frame according to the invention in a second embodiment,
a) in a sectional view,
b) in a top view;

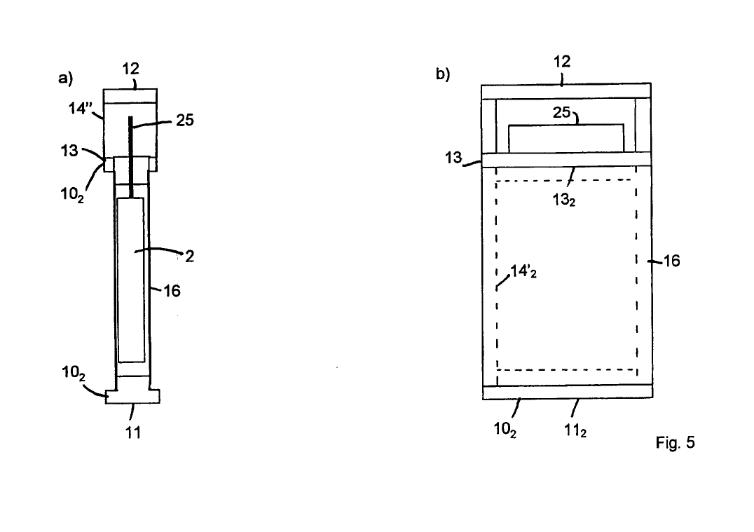

FIG. 5 shows a retaining frame according to the invention in a third embodiment,
a) in a sectional view,
b) in a top view;

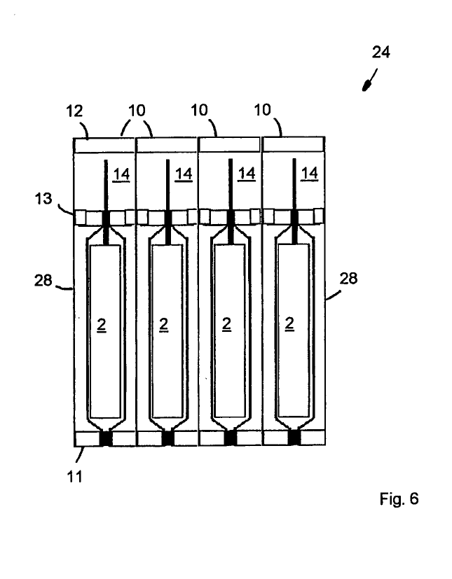

FIG. 6 shows a sectional view of a battery housing that is composed of a plurality of retaining frames in a modular fashion.

FIG. 1 shows a battery array 24. The battery array 24 comprises a battery housing 1, in which a plurality of battery cells 2 are disposed. The battery cells 2 comprise conductors 25, which can be connected in particular to conductors 25 of other battery cells by way of contacting elements, which are not shown. The battery housing 1 comprises a cover surface 3 and a bottom surface 4. The terms bottom surface and cover surface shall not be understood to be limiting with respect to the vertical orientation. A bottom surface does not have to face vertically downward, and a cover surface does not have to face vertically upward. The surfaces can have any arbitrary orientation. A sealing plate 5 is disposed between the cover surface 3 and the bottom surface 4. The sealing plate 5 separates the interior of the battery housing in two spaces, these being a contacting space 22 and a cooling space 23. The battery cells 2 extend through the sealing plate 5 through apertures 6. Sealing means 7 are disposed in an annular space formed between the battery cells 2 and the apertures 6. The sealing means 7 can be configured as sealing lips or as O-rings. For this purpose, the sealing means 7 can be received in a groove of the sealing plate 5. The groove can be disposed peripherally on the aperture 6. The sealing plate 5 can have an integral or a multi-part design.

It is apparent from FIG. 1b) that the sealing plate 5 has a multi-part design and is formed by a plurality of sealing plate elements 8. Each of the sealing plate elements 8 comprises the aperture 6 through which one of the battery cells 2 extends. Moreover, sealing plate elements 8₁ are provided that comprise no apertures. These elements are provided at the edge of the battery housing 1, where no battery cell is disposed. The sealing plate elements 8₁ that comprise no apertures can form outer ends of the sealing plate 5 that has a multi-part design.

The sealing plate 5, which, as is shown, can have an integral design or a multi-part design and be formed by a plurality of sealing plate elements 8, hermetically divides the interior of the battery housing into two spaces. A medium, which is provided in the cooling space 23 for cooling the battery cells, thus cannot penetrate into the contacting space 22. The contacting of the conductors 25 is simplified in the contacting space 22 because now specific sealing of the individual conductors 25 with respect to the surroundings in the contacting space 22 is no longer required.

The sealing plate 5 is preferably provided at the level of a conductor seal 26. The conductor seal 26 is the region of the battery cell 2 at which the conductor 15 extends through the jacket 16 of the battery cell 2. The battery cell is typically narrower in the region of the conductor seal 26 than in other regions of the battery cell 2, so that in general a smaller, in particular a narrower, aperture 6 that is to be sealed is provided.

FIG. 2a) shows a sealing plate element 8 in a first embodiment. The aperture 6 is disposed centrally in the sealing plate element 8 and completely enclosed by the sealing plate element 8. The sealing plate element 8 encloses the aperture 6 in an O shape. As an alternative, FIG. 2b) shows a second embodiment of a sealing plate element 8′. Here, the aperture 6′ is designed as a semi-open aperture and has the shape of an indentation. The sealing plate element 8′ is designed in a U shape around the aperture 6′.

FIG. 3 shows a battery cell 2 comprising a jacket 16 that is held in a retaining frame 10 according to the invention. The retaining frame 10 comprises a bottom part 11, a cover part 12, and a sealing part 13. The bottom part 11, the cover part 12, and the sealing part 13 are substantially formed by horizontal struts. Connecting means 14 are provided. First connecting means are configured as vertical struts 14′ and connect the cover part 12 to the sealing part 13. Second connecting means are provided in each case in the form of vertical struts 14″ and connect the bottom part 11 to the sealing part 13. This produces a retaining frame 10 having a rectangular peripheral design.

FIG. 3a) shows in particular that a groove 18 is provided on the bottom part, with a fastening flange 19 of the battery cell 2 extending into this groove. The groove 18 is also provided on the sealing part 13. The groove 18 is also present on the struts 14″ connecting the sealing part 13 to the bottom part 11, however this is not shown. The groove 18 is configured in this respect as a peripheral groove, which extends once around a rectangular frame that is formed by the sealing part 13, bottom part 11 and connecting means 14″. The groove receives the edge of the battery cell 2 which is configured as a fastening flange 19.

In the present case, the groove 18 is configured to be continuous, which is to say it separates the retaining frame 10 in two frame halves 10′ and 10″. Inserting the battery cell 2 in the retaining frame is thus simplified because the battery cell 2 is first placed on one of the frame halves 10′, 10″ and subsequently the other frame half 10″, 10′ is placed on the inserted battery cell 2. Optionally, the two frame halves 10′, 10″ can be braced with respect to each other, so that the battery cell is held rigidly inside the retaining frame 10.

FIG. 4 shows a retaining frame 10₁ in a second embodiment. In principle, this retaining frame corresponds to the retaining frame according to the first embodiment of FIG. 3. Hereafter, only the differences will be addressed. The retaining frame 10₁ comprises a reinforcement plate 17, which extends perpendicularly from the bottom part 11 to the sealing part 13. The reinforcement plate 17 is disposed parallel to an orientation of the battery cell 2. The reinforcement plate 17 is disposed inside the jacket 16 of the battery cell 2. The reinforcement plate 17 is disposed between cell stacks 27 of the battery cell 2.

The reinforcement plate 17 can be used as a heat conducting plate and dissipate heat from the cell stacks 27 to an outer region of the battery cell 2. Contrary to the retaining frame 10 of FIG. 3, the retaining frame 10₁ does not comprise any struts 14′ between the sealing part 13 and the bottom part 11.

FIG. 5 shows a retaining frame 10₂ in a third embodiment. In principle, this retaining frame corresponds to the retaining frame according to the first embodiment of FIG. 3. Hereafter, only the differences will be addressed. In addition to the bottom part 11 and the sealing part 13, the retaining frame 10₂ comprises a frame that is partially disposed inside the jacket 16. The jacket 16 is thus flange-mounted to sections of the bottom part 11₂ and of the sealing part 12₂. Moreover, the jacket 16 is flange-mounted to the hidden struts of the retaining frame 10₂ which are indicated by dashes. The retaining frame 10₂ as such constitutes a part of the seal of the jacket 16.

FIG. 6 shows a battery array 24 that is composed in a modular fashion of a plurality of retaining frames 10 and battery cells 2 disposed in the retaining frame 10. Parts of the battery housing 1 are formed by different parts of the retaining frames 10. For example, the cover surface of the battery housing 1 is formed by a plurality of cover parts 12 of the retaining frames 10. Moreover, the bottom surface 4 of the battery housing 1 is formed by a plurality of bottom parts 11 of the retaining frames 10. Furthermore, the sealing plate 5 of the battery housing 1 is formed by a plurality of sealing parts 13 of the retaining frames 10. The bottom parts 11 and cover parts 12 are seated sealingly against one another, so that the parts 11, 12, 13 in each case produce sealed surfaces or plates. The individual retaining frames 10 can be rigidly connected to each other by connecting means, which are not shown. To this end, notably tensioning means can be provided that brace the retaining frames 10 with respect to each other. Closing plates 28 are provided at each of the axial ends of the battery housing 1 and close off the battery housing 1. Like the remaining parts of the retaining frames, lateral struts 14 of the retaining frames 10 are located adjacent to each other and delimit the battery housing laterally.

### LIST OF REFERENCE NUMERALS

1 Battery housing
2 Battery cell
3 Cover surface
4 Bottom surface
5 Sealing plate
6 Aperture
7 Sealing means
8 Sealing plate element
9 Clearance
10 Retaining frame
11 Bottom part
12 Cover part
13 Sealing part
14 Connecting means
15 Frame half
16 Jacket
17 Reinforcement plate
18 Groove
19 Fastening flange
20 Closing plate
21 Axial end
22 Contacting space
23 Cooling space
24 Battery array
25 Conductor
26 Conductor seal
27 Cell stack
28 Connecting plate

1. A battery housing (1) for receiving one or more battery cells (2), comprising
a cover surface (3),
a bottom surface (4), and
a sealing plate (5) disposed between the cover surface and bottom surface,
characterized in that
the sealing plate separates a first space of the battery housing from a second space of the battery housing, the first space being provided for the electric contacting of the battery cells, and the second space being provided for cooling of the battery cells.

2. The battery housing according to claim 1,
characterized in that
the first space is equipped for the electric contacting of the battery cells and the second space is equipped for cooling of the battery cells.

3. The battery housing according to claim 2,
characterized in that
the first and second spaces are designed so that, in an assembled state,
the current conductors of a battery cell extends into this first space, and
the majority of a battery cell, in particular the heat conducting sections of a battery cell, extend into this second space in an assembled state.

4. The battery housing (1) according to the preceding claim,
characterized in that
the sealing plate (5) has an integral design.

5. A battery housing (1) according to any one of the preceding claims,
characterized in that
the sealing plate (5) has a multi-part design.

6. A battery housing (1) according to any one of the preceding claims,
characterized in that
the sealing plate (5) comprises at least one, in particular a plurality of apertures (6).

7. A battery housing (1) according to any one of the preceding claims,
characterized in that
a sealing plate (5) is formed by a plurality of sealing plate elements (8), with a plurality of sealing plate elements (8) being disposed in a plane.

8. The battery housing (1) according to the preceding claim,
characterized in that
the aperture (6) is formed by a clearance formed between two sealing plate elements (8) disposed next to each other.

9. The battery housing (1) according to the preceding claim,
characterized in that
the aperture (6) is provided with sealing means (7).

10. A retaining frame (10) for a battery cell (2) according to any one of the preceding claims, comprising
a bottom part (11),
a cover part (12), and
a sealing part (13) disposed between the bottom part and cover part.

11. The retaining frame (10) according to the preceding claim,
characterized in that
connecting means (14) are provided between the cover part (12) and the sealing part (13) and/or between the sealing part (13) and the bottom part (11).

12. The retaining frame (10) according to either claim 10 or 11,
characterized in that
the retaining frame (10) is designed as a peripheral frame.

13. A retaining frame (10) according to any one of claims 10 to 12,
characterized in that
the retaining frame (10) is formed by two frame halves (15).

14. A retaining frame (10) according to any one of claims 10 to 13,
characterized in that
the retaining frame (10) is disposed at least partially inside a jacket (16) of the battery cell (2).

15. A retaining frame (10) according to any one of claims 10 to 14,
characterized in that
the retaining frame (10) is disposed outside of a jacket (16) of the battery cell (2).

16. A retaining frame (10) according to any one of claims 10 to 15,
characterized in that
the retaining frame (10) comprises a reinforcement plate (17).

17. A retaining frame (10) according to any one of claims 10 to 16,
characterized in that
the sealing part (13) comprises an aperture (6), which is preferably provided with sealing means (7).

18. A retaining frame (10) according to any one of claims 10 to 17,
characterized in that
the retaining frame (10) comprises a peripheral groove (18) for receiving a fastening flange (19) of a battery cell (2).

19. A retaining frame (10) according to any one of claims 10 to 18,
characterized in that
a jacket (16) of the battery cell (2) is flange-mounted to sections of the retaining frame.

20. A battery housing (1) according to any one of claims 1 to 9, comprising a plurality of retaining frames (10) according to any one of claims 10 to 19.

21. The battery housing (1) according to the preceding claim,
characterized in that
the cover surface (3) is formed by a plurality of cover parts (12), the bottom surface (4) is formed by a plurality of bottom parts (11), and the sealing plate (5) is formed by a plurality of sealing parts (13).

22. A method for producing a battery housing (1) according to either claim 20 or 21, comprising the following steps:
placing a first retaining frame (10) against a second retaining frame (10),
placing closing plates (28) at the axial ends (21) of the battery housing (1).
